(19) United States
(12) Patent Application Publication
(10) Pub. No.: US 2015/0055354 A1
(43) Pub. Date: Feb. 26, 2015

(54) LED FIXTURE APPARATUS AND MANUFACTURING METHODS THERETO

(71) Applicant: Brilliance LED, LLC, Carefree, AZ (US)

(72) Inventors: Ronald Mueller, Cave Creek, AZ (US); Bryan Gold, Carefree, AZ (US)

(21) Appl. No.: 14/468,359

(22) Filed: Aug. 26, 2014

Related U.S. Application Data
(60) Provisional application No. 61/959,644, filed on Aug. 26, 2013.

(51) Int. Cl. F21K 99/00; F21V 23/00; F21V 29/00

(52) U.S. Cl. CPC F21K 9/135; F21V 29/2212; F21V 23/005; F21K 9/90; F21Y 2101/02
USPC 362/373

(57) ABSTRACT

An improved led fixture apparatus and manufacturing methods thereto is disclosed herein. In preferred embodiments, the apparatus comprises a power supply, a base, a circuit board mounted within the base, a LED connected to the circuit board, and wherein the base is constructed from material comprising forged metal and configured to act as a heat sync. In preferred embodiments, the base is made from forged aluminum alloy anodized for emissivity conduction and comprises a plurality of fins adapted to increase the surface area of the base to improve heat dissipation.

### CROSS REFERENCE TO RELATED APPLICATIONS

The present application claims priority to co-pending U.S. provisional patent application No. 61/959,644 filed Aug. 26, 2013, and entitled “NOVEL LED BASE FIXTURE DESIGN AND MANUFACTURING METHODS THERETO” the entire contents of the above-referenced patent application is incorporated by reference herein.

### APPENDIX TO THE SPECIFICATION

The present application contains an appendix labeled “Appendix-A” containing tables and related details of an improved led fixture apparatus and manufacturing methods thereto. The entire contents of which are incorporated by reference herein.

### FIELD OF THE INVENTION

The present invention relates to the field lighting fixtures. More specifically, the invention relates to new light emitting diode (LED) fixtures and methods of manufacturing.

### BACKGROUND

Traditionally LED lighting fixtures are made by companies that utilize labor intensive manufacturing techniques because of the low skill level required to produce LED lamps. The low skill level allows for lower wage requirements for the labor and therefore affords lower production costs. The higher ratio of manual tasks supplemented by immature automation and assembles tasks per hour approaches a ratio of about 18.5:1 in most low wage factories. Companies like GE, Osram, Philips, Arrow electronics, outsource to low wage manufacturers for this reason in Asia like, Seoul Semiconductor, Neng TYI, A Bright, Gana Industries, Xiamen electronics, Bright Led electronics and many others are major manufacturers. The result of low skilled labor intensive light fixture assembly methods is lower quality and lower fixture luminosity output as the basic fixture design and assembly practices are copied from the old industry standards rather than utilizing an integrated design simplified for automation, for reducing manual labor, and for reducing the number of parts required in the assembly. The state of the assembly practices is mechanization and not automation because of the base design and low wage method of assembly, especially for high-power High value LED light fixtures.

Since its introduction into the market in 1994 white high-power LED has improved immensely and now it can compete with traditional light sources. High Power LEDs are found in all sort of lighting applications from desk lamp, kitchen lamp to commercial High Bay and street lights. One of the important aspects of LED fixture design is to transfer the heat efficiently from the LED junction to the ambient surroundings. The life of the LED is influenced by its junction temperature. For example, an increase of 10° C. can decrease the lifetime of some LEDs by about 43 percent and a 20° C. increase can further decrease the lifetime by about 67 percent. In an LED the primary path of heat transfer is conduction from the junction to the LED printed circuit board. Without good thermal management, the internal (junction) temperature of the LED rises, and this affects the performance and reliability of the fixtures and LEDs. The excess heat could result in color shift and an accelerated reduction in light output resulting in a shortened life for the LED and the fixture.

Therefore, a need exists for novel light emitting diode (LED) fixtures and methods of manufacturing. There is a further need for novel light emitting diode (LED) fixtures and methods of manufacturing that are not labor intensive for automated assembly practices. Finally, there exists a need for novel light emitting diode (LED) fixtures and methods of manufacturing that are able to rapidly dissipate heat to prevent an accelerated reduction in light output resulting in a shortened life for the LED and the fixture.

### BRIEF SUMMARY OF THE INVENTION

An improved LED fixture apparatus and manufacturing methods thereto is disclosed herein. In preferred embodiments, the apparatus comprises a power supply, a base, a circuit board mounted within the base, a LED connected to the circuit board, and wherein the base is constructed from material comprising forged metal and configured to act as a heat sync. In preferred embodiments, the base is made from forged aluminum alloy anodized for emissivity conduction and comprises a plurality of fins adapted to increase the surface area of the base to improve heat dissipation.

In some additional embodiments, the base may comprise a mounting shelf coated with a thermally conductive material and the mounting shelf may be configured to connect the base to a circuit board. In yet further embodiments, a base may comprise a thermally conductive electrically insulative base plug which may be configured to seal out moisture while allowing the power source to be inserted into the base and mechanically crimped to the circuit board.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a perspective view of an example of an improved LED fixture apparatus according to various embodiments described herein.

FIG. 2 illustrates an exploded perspective view of an example of an improved LED fixture apparatus according to various embodiments described herein.

FIG. 3 shows a sectional, through line 3-3 shown in FIG. 1, elevation view of an example of an improved LED fixture apparatus according to various embodiments described herein.

FIG. 4 depicts an elevation view of the side of an example of a base according to various embodiments described herein.

FIG. 5 illustrates a perspective view of the top side? of an example of a base according to various embodiments described herein.

FIG. 6 shows a plan view of the top of an example of a base according to various embodiments described herein.

FIG. 7 depicts a plan view of the bottom of an example of a base according to various embodiments described herein.

FIG. 8 illustrates a perspective view of the bottom of an example of a base according to various embodiments described herein.

FIG. 9A shows a top perspective view of an example of a base plug according to various embodiments described herein.

FIG. 9B depicts a bottom perspective view of an example of a base plug according to various embodiments described herein.

FIG. 10 illustrates a perspective view of the side of an example of socket connector wires and wire retainers according to various embodiments described herein.

FIG. 11A shows a perspective view of the bottom of an example of a connector board according to various embodiments described herein.

FIG. 11B depicts a perspective view of the top of an example of a connector board according to various embodiments described herein.

FIG. 12 illustrates a perspective view of the top of an example of circuit board and a connector board according to various alternative embodiments described herein.

FIG. 13 shows a perspective view of the bottom of an example of a circuit board, socket connector wires, and a base plug according to various embodiments described herein.

FIG. 14 depicts a perspective view of the top of an example of a circuit board, socket connector wires, and a base plug according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

It should be understood that for the purposes of understanding the orientation of individual elements of the invention, the term “top” shall generally be used to indicate a surface of an element that when assembled in a LED base fixture apparatus is positioned closer to or orientated toward the light emitting source on the apparatus. Conversely, for the purposes of understanding the orientation of individual elements of the invention, the term “bottom” shall generally be used to indicate a surface of an element that when assembled in a LED base fixture apparatus is positioned farther from or orientated away the light emitting source on the apparatus.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New and improved LED fixture apparatuses and manufacturing methods thereto are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

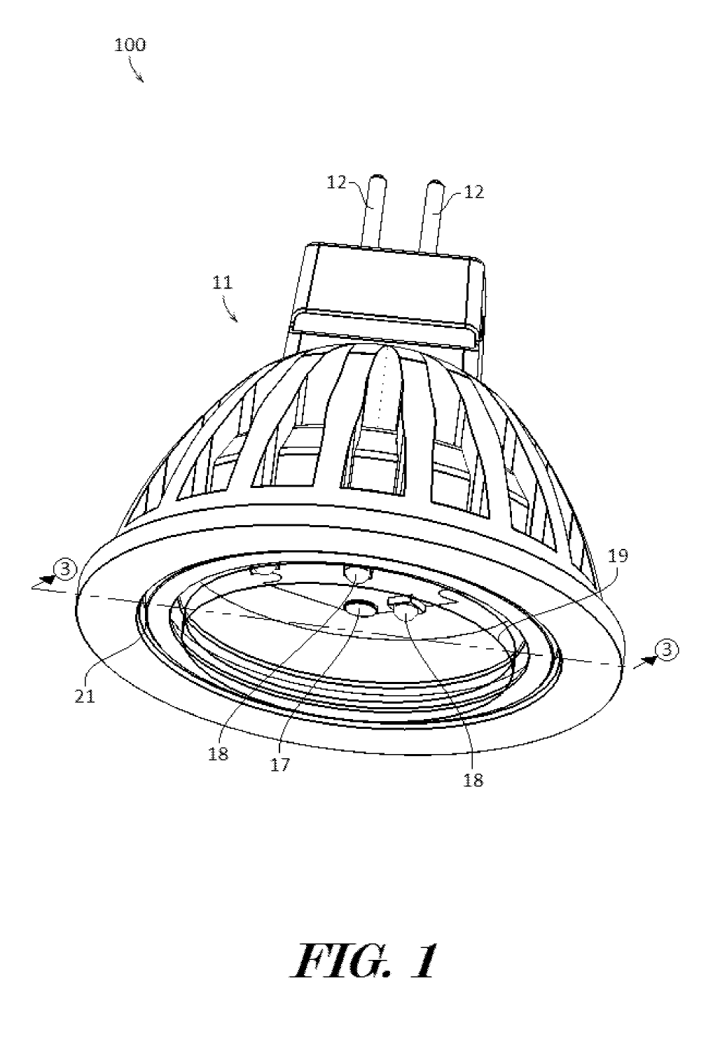

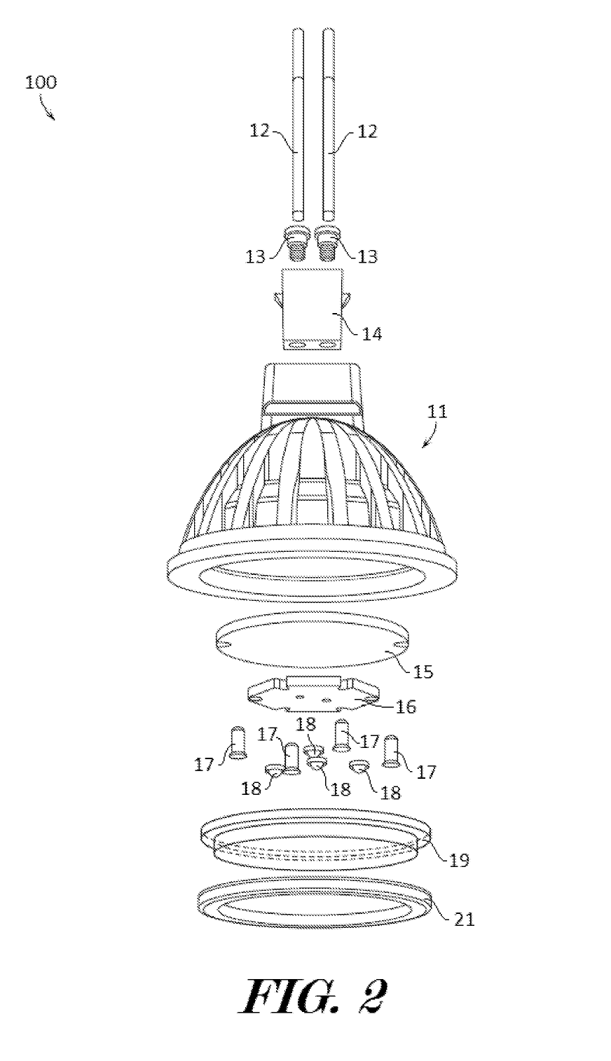

The present invention will now be described by example and through referencing the appended figures representing preferred and alternative embodiments. FIGS. 1 and 2 illustrate an example of an improved LED fixture apparatus (“the apparatus”) 100 according to various embodiments. In this example, the apparatus 100 comprises a base 11 which forms the structural support to which the elements of the apparatus 100 may be secured to. This example of the apparatus 100 also comprises a power supply 12, two wire retainers 13 (FIG. 2), a base plug 14 (FIG. 2), a circuit board 15 (FIG. 2), an optional connector board 16 (FIG. 2), one or more optional fasteners 17, one or more optional LED lenses 18, an outer lens 19, and a retainer ring 21.

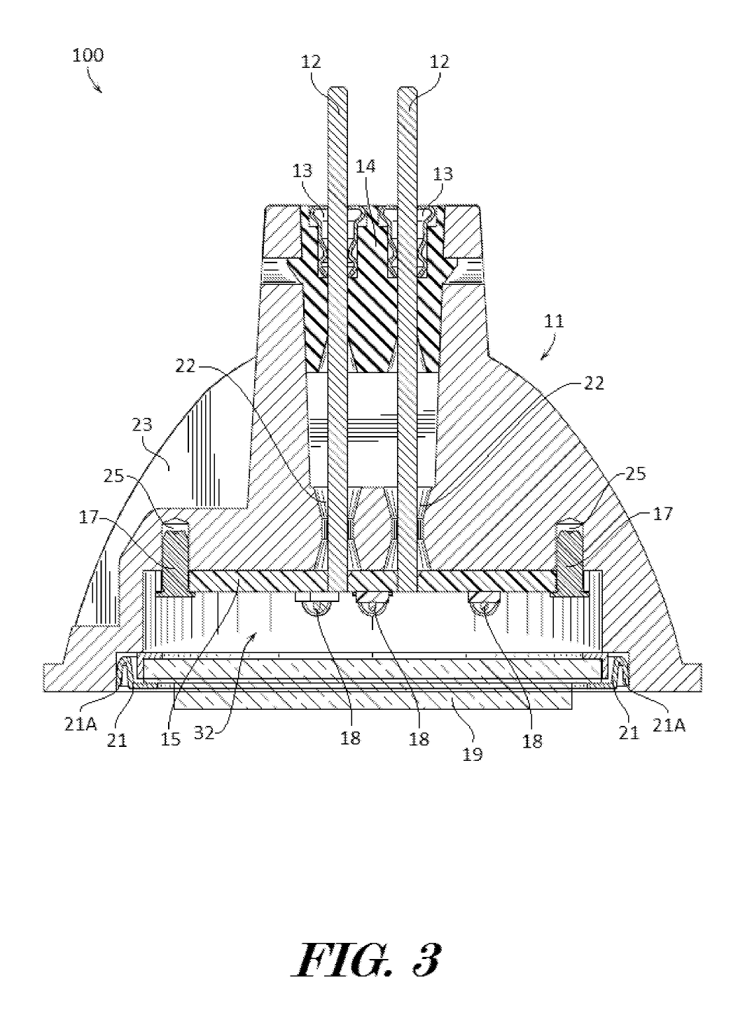

FIG. 3 shows a sectional, through line 3-3 shown in FIG. 1, elevation view of an example of an improved LED fixture apparatus 100 according to various embodiments described herein. In this embodiment, the apparatus 100 is shown without an optional connector board 16. The general positioning of some of the elements of the apparatus 100 can be seen in FIG. 3 with a circuit board 15 secured to the base 11 with fasteners 17. In this and preferred embodiments, the circuit board 15 may comprise one or more LED light elements with one or more optional LED lenses 18 positioned over the LED light elements. In other embodiments, the circuit board 15 may comprise one or more other light emitting elements such as incandescent light bulbs, halogen light bulbs, laser light emitters, electroluminescent light sources, neon light sources, or any other suitable light source. In some embodiments, a power source 12 may comprise two socket connector wires and may provide a power source and electrical connection for the circuit board 15, optional connector board 16 (FIG. 2), and the LED light elements.

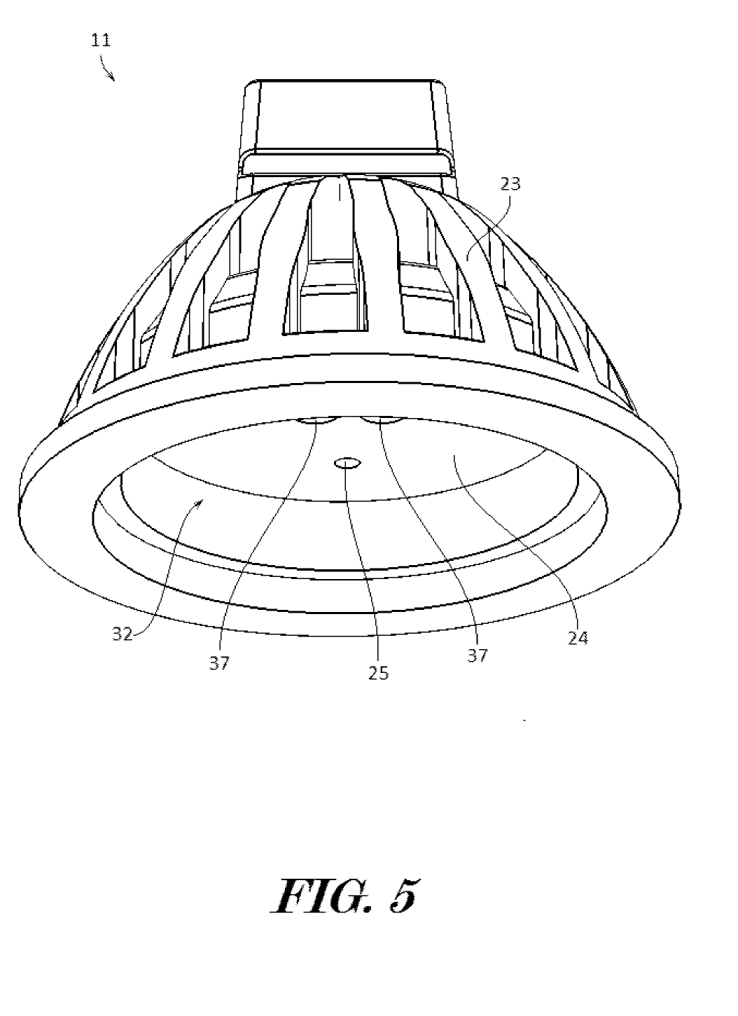

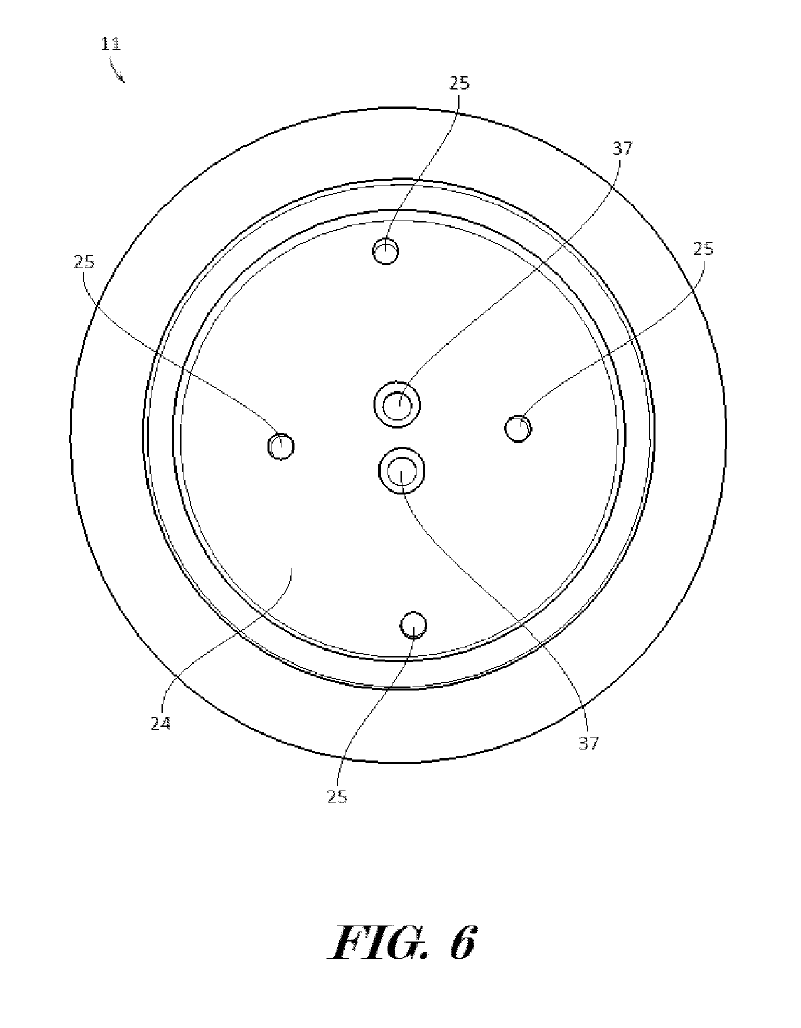

The power supply 12 such as socket connector wires may protrude from the base 11 to engage light sockets, fixture sockets, and the like. In preferred embodiments, power supply 12 may be placed through the bottom of the base 11, through base wire conduits 37 (FIGS. 5 and 6) though wire guides 22, and press fit, swaged, and/or mechanically crimped into the circuit board 15 and/or the connector board 16. A wire guide 22 and/or a base wire conduit 37 may be formed into the base 11 through forging and they may function as a kinematic coupling to funnel or otherwise direct a power source 12 and assure that the power source 12 can be inserted without snagging when it is inserted either from the top or bottom of the base 11. In other embodiments, other kinematic couplings, guides, and the like may be used. The inserted power source 12 may be held in place by a base plug 14 and/or one or more wire retainers 13.

As shown in FIGS. 1-3, the outer lens 19 may be secured to the top of the base 11 to allow light to exit from the apparatus 100, and it may also seal out moisture and dirt. In preferred embodiments, the outer lens 19 and the base 11 may each comprise one or more ridges or grooves. The base 11 may comprise ridges or grooves along portions of the base 11 configured to secure to the outer lens 19. Likewise, the outer lens 19 may comprise ridges or grooves along portions of the outer lens 19 configured to secure to the base 11. In this manner, the grooves or ridges on the outer lens 19 and the base 11 may be configured to mate together to form a seal or junction such as a labyrinth seal. In other embodiments, the outer lens 19 may be joined or preferably sealed to the base 11 with a temporary joining method such as a push-to-lock type connection method, a turn-to-lock type connection method, slide-to-lock type connection method, by being press fit or snap fit together, with a gasket connection, by one or more fasteners such as sealable tongue and groove fasteners, clip type fasteners, clasp type fasteners, ratchet type fasteners, threaded type fasteners such as screws, by being permanently joined with heat bonding, chemical bonding, adhesives, rivet type fasteners, or any other suitable temporary connection method as one reasonably skilled in the art could envision to serve the same function.

The outer lens 19 may be made from Poly(methyl methacrylate) PMMA acrylic, glass, resins, high temperature plastics, or any other suitable light transmitting material. In preferred embodiments, the outer lens 19 may be a variable shaped beam lens that is shaped to allow light to exit at a variable angles to produce a variety of beam angles per user requirement with one or more spot light beams or flood light beams in a variety of angles per LED light element. In some embodiments, the outer lens 19 may be fitted over the LED light elements in a cone shape to capture the maximum light output from the LED light elements into light beams such as spot light beams and flood light beams.

In preferred embodiments, a retainer ring 21 may be press fit into the top of the base 11 around the outer lens 19. A retainer ring 21 may be made from aluminum, steel, other metal alloys, hard plastics, ceramics, resins, or any other suitable material, and a retainer ring 21 may be configured to hold the outer lens 19 securely into the base 11 and may be configured to seal the base 11 and the outer lens 19 together for outdoor weather and other adverse environment applications.

Also in preferred embodiments, the retainer ring 21 may comprise a tamper proof or tamper evident seal such as a barb like protrusion 21A around its circumference or along one or more portions which may be press fit into a complementary ring, groove, aperture, or the like on the base 11. For example, the retainer ring 21 may be configured to overlap the junction of the base 11 and the outer lens 19 to seal and retain the outer lens 19 in place with one or more barbed fish hook protrusions which may each be press fit in the cavity 32 of the base 11 thereby hindering the removal of the outer lens 19 without damaging the barbed protrusion as evidence of tampering.

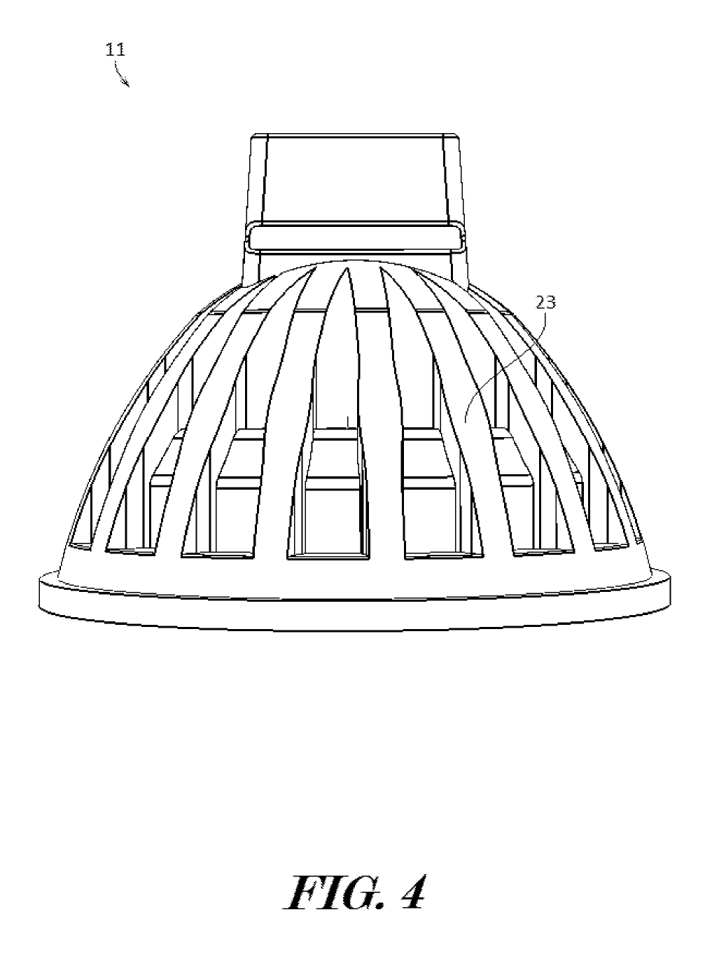

Turning now to FIGS. 4-8, various views of an example of a base 11 according to various embodiments described herein are depicted. In preferred embodiments, a base 11 may be of a one piece uni-body design, by combining the base connector housing and the lamp body, and forged or made from a single piece of material which may be coated with additional materials. The base 11 may be made from aluminum, copper, steel, or any other metal alloys including combinations of metal alloys such as aluminum and copper, and the base 11 may preferably be formed with a forging process for tight molecular structure and for conduction efficiency. In some preferred embodiments, the base 11 may comprise aluminum and may be forged using a two part mold. In further preferred embodiments, the base 11 may be made from forged aluminum and comprise one or more portions that are flash coated or otherwise coated with copper or other metal alloys. In yet further preferred embodiments, the base 11 may be made from forged aluminum and comprise one or more portions that are flash coated or otherwise coated with copper or other metal alloys with one or more aluminum and/or copper surfaces coated with nanoparticles or other nanostructured applications of material such as a nanostructured application of zinc oxide. In still further embodiments, the base 11 may be forged with an aluminum alloy and may be anodized for emissivity conduction.

In preferred embodiments, the base 11 comprises a plurality of fins 23 which may be forged, welded, molded, or otherwise joined to portions of the base 11. The fins 23 may be configured to increase the surface area of the base 11 and may be used to provide superior surface area for thermal emissivity and heat dissipation. In some embodiments, the base 11 may comprise between one and fifty fins 23. In preferred embodiments, the base 11 may comprise between fifteen and twenty fins 23. In other embodiments, the base 11 may comprise any number of fins 23 which are preferably forged into the base 11.

As illustrated in FIGS. 5, 6, and 7, the base 11 may comprise one or more, but preferably two base wire conduits 37 which may be configured to allow a power source 12 (FIGS. 1-3) such as socket connector wires to pass through the base 11 and into the cavity 32. In preferred embodiments, a base wire conduits 37 may comprise a wire guide 22 (FIG. 3) which may be configured to guide a power source 12 such as socket connector wires to pass through the base wire conduits 37 of the base 11 and guide the wires into the circuit board 15 (FIGS. 1-3) and/or into the optional connector board 16 (FIGS. 1 and 2). The wire guides 22 and/or base wire conduits 37 may be forged, cut, drilled, or otherwise formed into the base 11. In other embodiments, the base 11 may comprise any other suitable guide or kinematic coupling method configured to guide the movement or insertion of a power source 12 such as socket connector wires into or through the base 11.

The base 11 may also comprise a mounting shelf 24 which may form the bottom of the cavity 32, and which in preferred embodiments may be configured to contact the bottom or portions of the bottom of a circuit board 15 and/or connector board 16. In further preferred embodiments, a mounting shelf 24 may be forged into the base 11, coated with a thermally conductive material such as copper, and then it may be subsequently coated with another thermally conductive material such as nanoparticles or other nanostructured applications of material such as a nanostructured application of zinc oxide. The mounting shelf 24 preferably provides a surface for the circuit board 15 and/or connector board 16 to dissipate the heat away from the power connection of the LED light elements and into the base 11.

Also shown in FIGS. 3, 5, and 6, the base 11 may comprise one or more fastener apertures 25 which may be forged into or otherwise formed into the base 11 and which may be configured to receive and secure one or more fasteners 17 (FIGS. 2 and 3). Fastener apertures 25 may receive and secure fasteners 17 which may be used to secure a circuit board 15, a connector board 16, and/or any other element to the base 11.

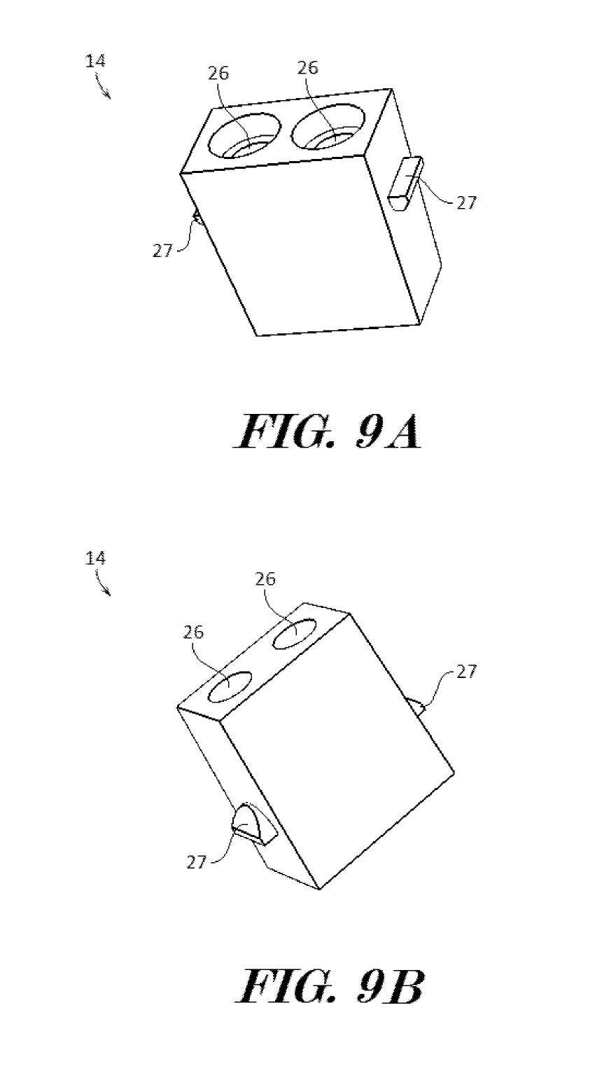

FIGS. 9A and 9B depict a perspective view of an example of a base plug 14 according to various embodiments described herein. In preferred embodiments, a base plug 14 is configured to conduct heat and to not conduct electricity. The base plug 14 may be made from any thermally conductive, and preferably electrically insulating thermoplastic elastomer (TPE) such as CoolPoly D8102 by Cool Polymers, Inc of Warwick, R.I., and HEATPAD® KU-TDFD which is a soft silicone film filled with thermally conductive ceramic by Kunze® Heat Management Company.

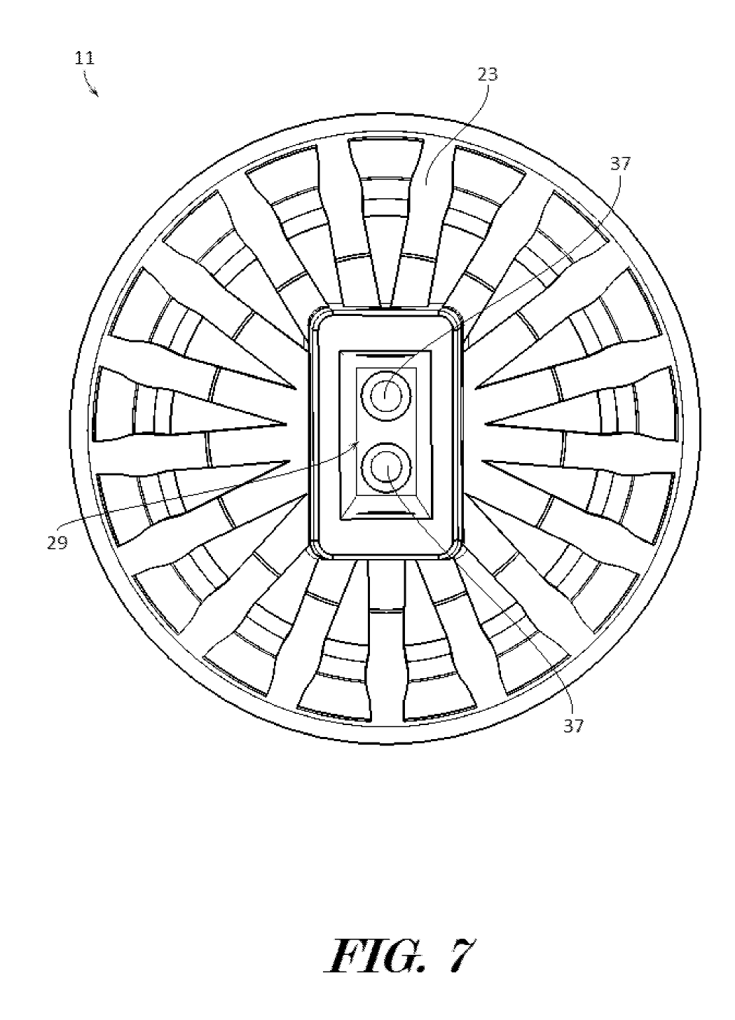

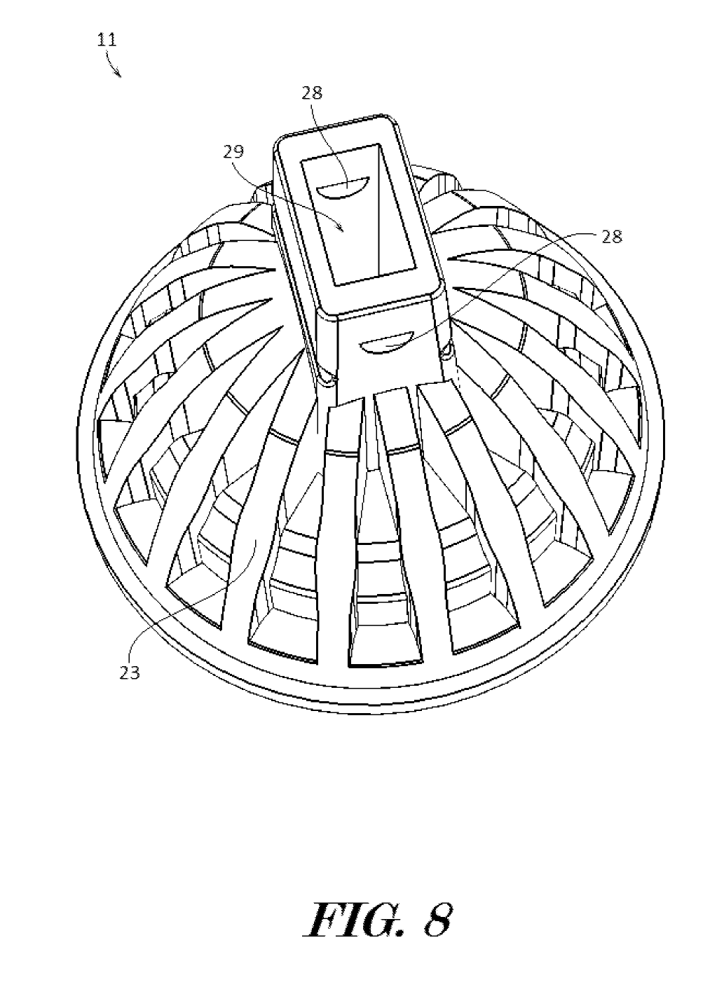

The base plug 14 may be formed or molded to comprise one or more optional barbed projections 27 which may be configured to press fit into, lock into, or otherwise secure into one or more complementary shaped barb catches 28 (FIGS. 3 and 8) or notches on a base 11 (FIGS. 1-8). Preferably, the apparatus 100 (FIGS. 1-3) may comprise a plug receptacle 29 (FIGS. 7 and 8) which may be forged into or otherwise formed into the base 11 and which is generally complementary in shape to the base plug 14. By pressing the base plug 14 into the plug receptacle 29, a barbed projection 27 may fit into a barb catch 28 thereby anchoring and securing the base plug 14 into the plug receptacle 29 of the base 11 with a watertight seal.

A base plug 14 may also comprise one or more base plug wire conduits 26 which may be configured to allow a power source 12 such as socket connector wires to pass through the base plug 14 and to stabilize the wire from bending while aiding in the dissipation of heat. Additionally, one or more of the base plug wire conduits 26 may be configured to receive and secure a wire retainer 13 (FIGS. 2, 3, 9, 10, and 13). A wire retainer 13 may be press fit, molded, or otherwise inserted into a base plug wire conduit 26 of a base plug 14, preferably in the bottom side of the base plug 14, as shown in FIG. 3.

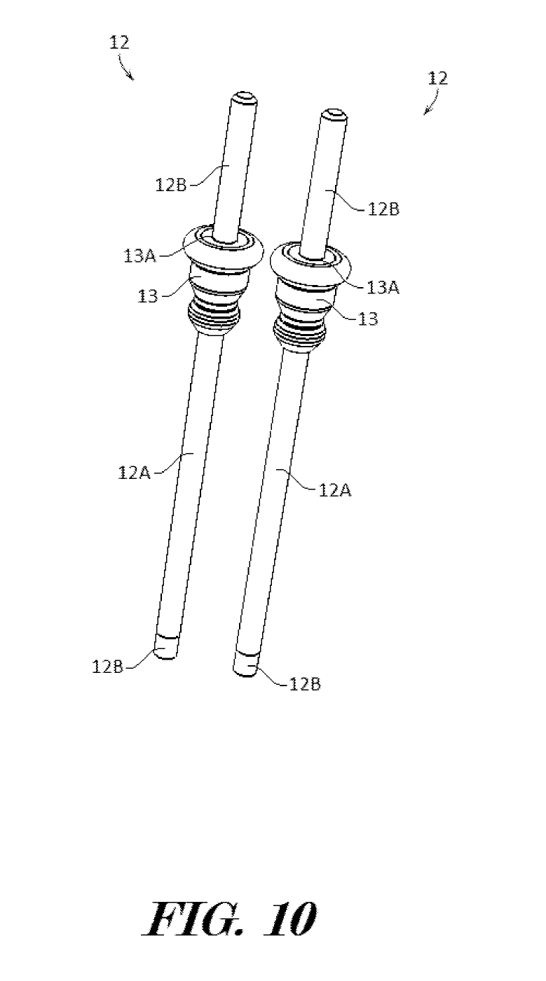

FIG. 10 illustrates a perspective view of the bottom of an example of a power source 12 and two wire retainers 13 according to various embodiments described herein. A wire retainer 13 may comprise a wire retainer conduit 31 which passes through the wire retainer 13 and may be configured to frictionally secure a power source 12 wire such as a socket connector wire therein to prevent the wire from moving towards or away from a circuit board 15 (FIGS. 2 and 3) and/or a connector board 16 (FIG. 2). In some embodiments, when the apparatus 100 (FIGS. 1-3) is pushed into an electrical socket, wire retainers 13 may prevent the wires from pushing through a circuit board 15 and/or a connector board 16 and disconnecting the circuit. In other embodiments, a wire retainer 13 may comprise a preferably resistive earring back design to prevent the wire from moving during installation. In further embodiments, a wire retainer 13 may function as a mechanical stop to prevent the wire from being pushed into a circuit board 15 and/or a connector board 16 in the z axis when installing the apparatus 100 into a light socket, and wire retainer conduit 31 may comprise a straight through hole that has a slight bend or bow in the middle to provide the mechanical or frictional resistance and to prevent the intrusion of water through the wire retainer conduit 31. A wire retainer 13 may be made from aluminum, other metals and metal alloys, hard plastics, ceramics, or any other suitable material including combinations of materials.

In preferred embodiments, the power source 12 may comprise Polytetrafluoroethylene (PTFE) or Teflon Polytetrafluoroethylene (TPTFE) insulated copper wire that extends from the circuit board 15 and/or a connector board 16 up through wire conduits 37 in the mounting shelf 24, through wire guides 22 in the base 11, through the plug receptacle 29, through the base plug 14 and wire retainers 13 (as shown in FIG. 3), and extending out from the bottom of the apparatus 100 (FIGS. 1-3) for engagement with light sockets and the like. Also in preferred embodiments, the insulation 12A on the conductive wire 12B may be configured to cover the conductive wire 12B from the mounting shelf 24, through the apparatus 100 with the conductive wire 12B being exposed for contact and to be mechanically crimped or joined with the circuit board 15 and/or a connector board 16 and exposed for contact with suitable bi-pin connectors and conductors common in light sockets, socket adapters, and the like.

The power source 12 may comprise copper spool wire PTFE coated for temperature and which may be pre-stripped for easy insertion into the apparatus 100 (FIGS. 1-3). The spool wire or optionally conventional insulated wire may be cut and appropriately stripped by machine during the inflow path or insertion into the apparatus 100. Preferably, the conductive wire 12B comprises a hardened copper which may be relatively not soft or malleable copper from a spool. In other embodiments, the conductive wire 12B may comprise a relatively soft malleable copper from a spool.

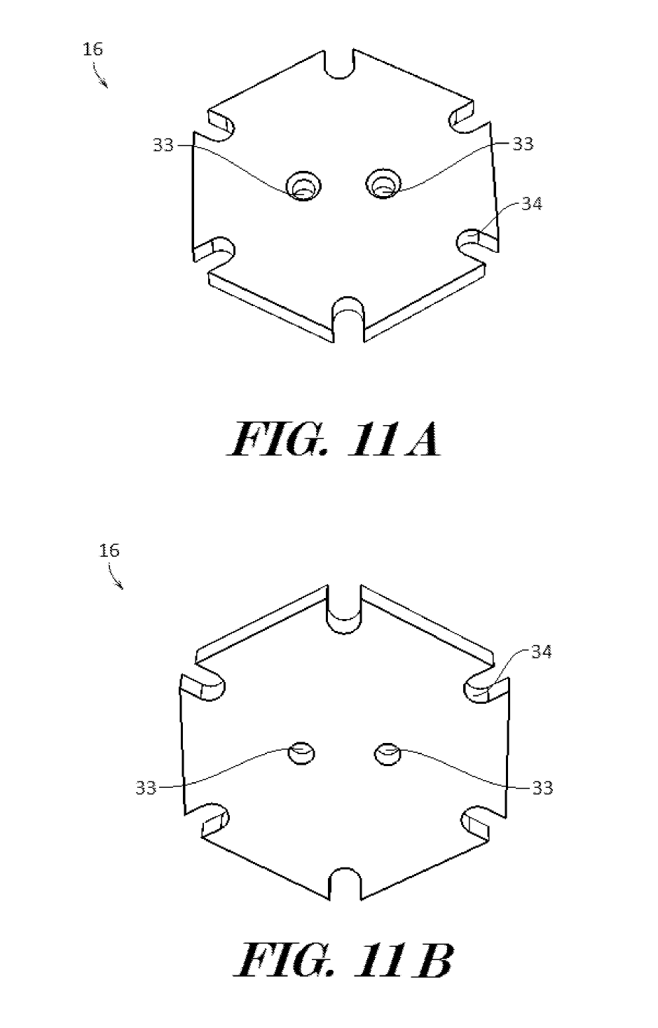

FIG. 11A shows a perspective view of the bottom of an example of a connector board 16 while FIG. 11B depicts a perspective view of the top of an example of a connector board 16 according to various embodiments described herein. An apparatus 100 (FIGS. 1-3) may optionally comprise one or more circuit boards 16. A connector board 16 may comprise a printed circuit board or other circuit board and one or more connector board wire conduits 33 for receiving and joining to one or more socket connector wires 12 (FIGS. 1-3, 10, 13, and 14). A printed circuit board may comprise one or more layers or tiers of circuits which may be optionally stacked on each other. For example, a multi-layer circuit board may comprise a base or bottom which may be made from ceramic or other heat resistant material, a second metal or conductive layer for interconnects, a third pin out layer to mount the device and/or board to connect the chips, a fourth metal or conductive layer interconnect for the circuit connection, and a top layer to mount one or more LEDs and other accessory devices. In preferred embodiments, a connector board 16 may comprise a multi-layer or multi-tiered printed circuit board. In other preferred embodiments, a connector board 16 may comprise a multi-layer copper clad circuit board. In other preferred embodiments, a connector board 16 may comprise a multi-layer clad circuit board comprising other materials or clad with other materials.

A connector board 16 or other multi-tiered circuit board may preferably have solder ball technology to allow for mounting as a stacked height to feature the circuit functionality without excessive heating. Each layer may be water proofed to IP67 to protect against accidental shorting during operation. Also a connector board 16 may comprise a generally star shape or any other shape, with one or more connector board fastener apertures 34 located anywhere thereon which may receive and secure one or more fasteners 27 (FIGS. 2, 3, 12, and 13). A connector board fastener aperture 34 may comprise a round or circular shape, a notch or “C” shape, or any other shape capable of receiving and being secured by a fastener 17.

In some embodiments, the connector board 16 may comprise one or more LEDs, other light elements, and/or one or more accessory devices. An accessory device may comprise devices such as motion sensors for functions like motion control, light sensors for day and night lighting control, Blue tooth or other wireless protocol technology, multicolored lighting elements, wide versus narrow beam light elements, GPS sensors, solar time clock adjustment devices, speakers, processors for self-configuring based on IP address, Bluetooth or other wireless technology to convert to speaker systems, modulator sensors to synchronize the light elements with vibration and sound harmonics, phone communications, TV communications, and/or web based application sensors and devices.

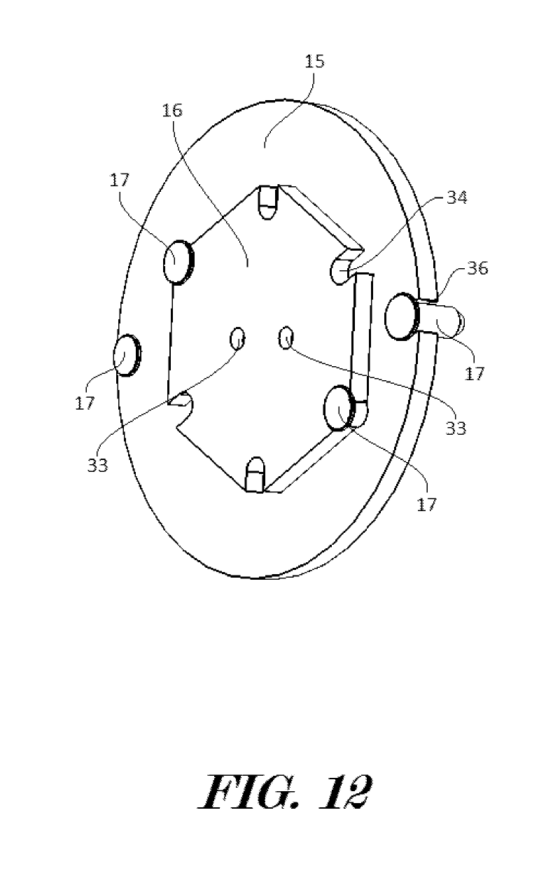

FIG. 12 illustrates a perspective view of the top of an example of connector board 16 and a circuit board 15 according to various alternative embodiments described herein. An apparatus 100 (FIGS. 1-3) may comprises one or more base boards 15. A circuit board 15 may comprise a printed circuit board or other circuit board and one or more circuit board wire conduits 35 for receiving and joining to a power source 12 (FIGS. 1-3, 10, 13, and 14). A circuit board 15 may comprise one or more layer or tiers of circuits which may be optionally stacked on each other. For example, a multi-layer circuit board 15 may comprise a base or bottom which may be made from ceramic or other heat resistant material, a second metal or conductive layer for interconnects, a third pin out layer to mount the device and/or board to connect the chips, a fourth metal or conductive layer interconnect for the circuit connection, and a top layer to mount one or more LEDs and other accessory devices. In preferred embodiments, a circuit board 15 may comprise a multi-layer or multi-tiered printed circuit board. In other preferred embodiments, a circuit board 15 may comprise a multi-layer copper clad circuit board. In other preferred embodiments, a circuit board 15 may comprise a multi-layer clad circuit board comprising other materials or clad with other materials.

A circuit board 15 or other multi-tiered circuit board may preferably have solder ball technology to allow for mounting as a stacked height to feature the circuit functionality without excessive heating. Each layer may be water proofed to IP67 to protect against accidental shorting during operation. Also a circuit board 15 may comprise a generally circular shape or any other shape, with one or more connector board fastener apertures 34 located anywhere thereon which may receive and secure one or more fasteners 17 (FIGS. 2, 3, 12, and 13). In preferred embodiments, a circuit board 15 may comprise a 30 millimeter (mm) circuit board providing a larger surface for heat dissipation. In other embodiments, a circuit board 15 may comprise a circuit board at or between 10 mm and 60 mm. Preferably, a circuit board 15 may comprise a circuit board mount 15A on its bottom surface which may comprise copper or other heat conducting metals and/or nanoparticles such as zinc oxide nanoparticles configured to contact and transfer heat to the mounting shelf 24 (FIGS. 3, 5, and 6).

In some embodiments, a circuit board 15 and/or connection board 16 may comprise an adaptable common board design that can be tailored to add or delete features without requiring a new “Gerber” or other type of printed circuit board. Also in some embodiments, a circuit board 15 may be fully customizable by laser trimming or cutting. In further embodiments, a circuit board 15 and/or connection board 16 may comprise a plug-in add-on communications adapter which may be used to provide additional functions and communication with accessory devices and a rapid response to customer requirements.

In preferred embodiments, a connector board 16 may be stacked with a circuit board 15 (FIGS. 1-3 and 12-14) in the cavity 32 (FIGS. 2, 3, 5, and 6) and preferably with a space between them which may allow for convective cooling. In preferred embodiments, a circuit board 15 and/or a connector board 16 may be aligned using cup and ball or other kinematic methods to aid in automatic alignment using kinematic principles for precise alignment essential for inserting the socket connector wires 12 (FIGS. 1-3, 10, 13, and 14) thereby reducing assembly time.

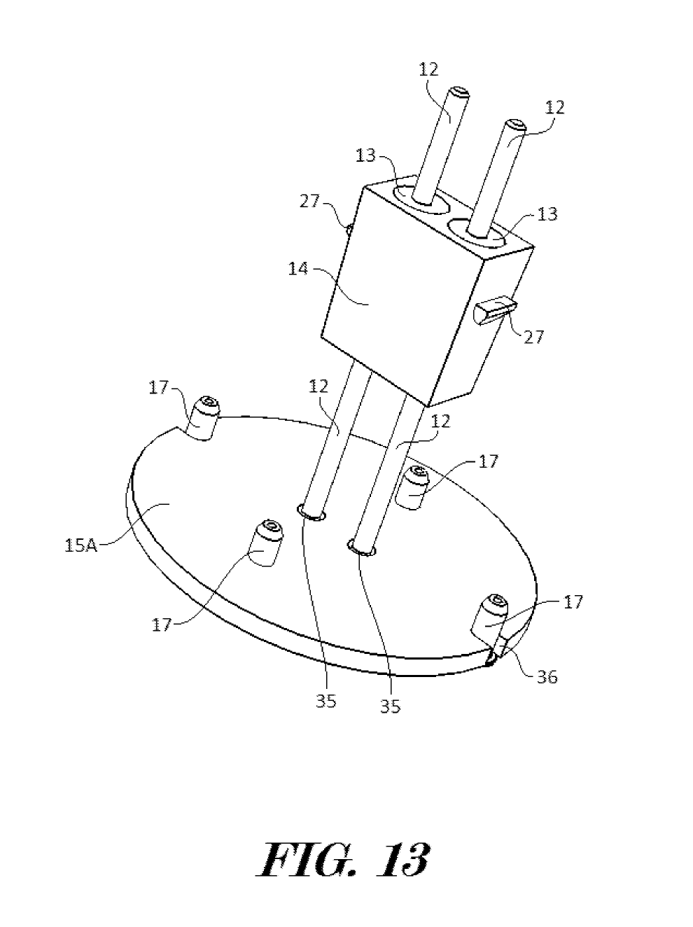

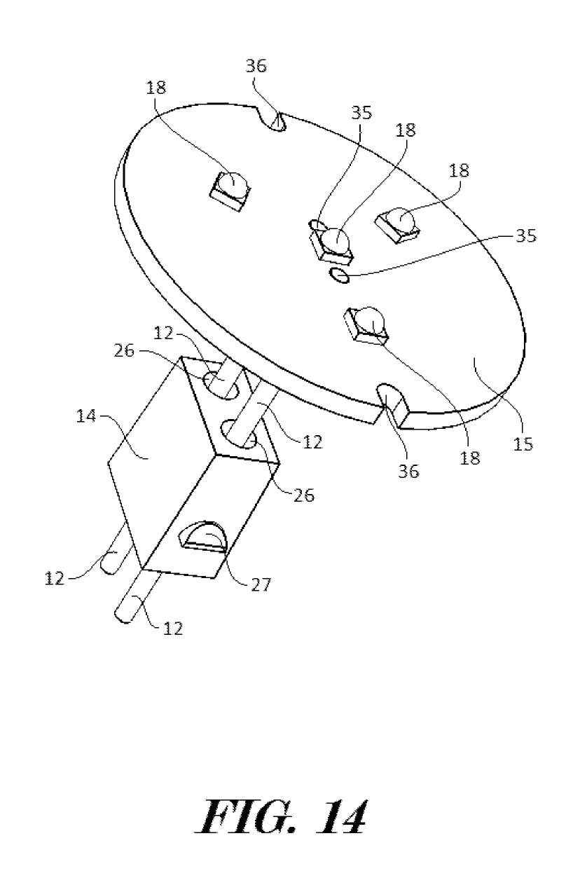

FIG. 13 shows a perspective view of the bottom of an example of a circuit board 15, power source 12, and a base plug 14 while FIG. 14 depicts a perspective view of the top of an example of a circuit board 15, power source 12, and a base plug 14 according to various embodiments described herein. In preferred embodiments, a circuit board 15 and/or a connector board 16 (FIGS. 1, 11, and 12) may be mechanically crimped, swaged, or otherwise press fit into electrical connection with the power source 12. In further embodiments, the power source 12, circuit board 15, and/or a connector board 16 may each comprise a labyrinth seal allowing them to be press fit together and joined. In still further embodiments, the power source 12, circuit board 15, and/or a connector board 16 may be joined together with any other method allowing electrical communication between them.

A circuit board 15 may comprise one or more circuit board fastener apertures 36 located anywhere thereon which may receive and secure one or more fasteners 27. A circuit board fastener aperture 36 may comprise a round or circular shape, a notch or “C” shape, or any other shape capable of receiving and being secured by a fastener 17. In preferred embodiments, a fastener 17 may comprise a rivet type fastener, micro connector fastener, or any other suitable fastener which may be mechanically press fit or crimped into a fastener aperture 25, connector board fastener aperture 34, and/or a circuit board fastener aperture 36 allowing one or more base boards 15 and/or optional circuit boards 16 to be secured to the base 11. In preferred embodiments, a fastener 17 may be used to secure one or more base boards 15 and/or optional circuit boards 16 to the base 11 without requiring threaded screw holes to be drilled. In other embodiments, a fastener 17 may comprise any fastener suitable for high temperature applications such as labyrinth seal fasteners, clip type fasteners, clasp type fasteners, ratchet type fasteners, and threaded type fasteners such as screws and bolts.

Also depicted in FIG. 14, one or more LED light elements or other types of light elements may be positioned anywhere on a circuit board 15 and/or on an optional connector board 16 and be configured to receive power supplied through the power source 12. One or more of the LED light elements or other types of light elements may comprise an optional LED lens 18 which may be made from PMMA acrylic, glass, resins, high temperature plastics, or any other suitable light transmitting material. In preferred embodiments, a LED lens 18 may be a variable shaped beam lens that is shaped to allow light to exit at a variable angles to produce a variety of beam angles per user requirement with one or more spot light beams or flood light beams in a variety of angles per LED light element. In some embodiments, a LED lens 18 may be fitted over the LED light elements in a cone shape to capture the maximum light output from the LED light elements into light beams such as spot light beams and flood light beams and may work in conjunction with the outer lens 19 to further direct the light emitted from the apparatus 100 (FIGS. 1-3).

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. An improved LED fixture apparatus, the apparatus comprising:
a. a power supply;
b. a base;
c. a circuit board mounted within the base;
d. a LED connected to the circuit board; and
wherein the base is constructed from material comprising forged metal and configured to act as a heat sync.

2. The apparatus of claim 1, wherein the base comprises a plurality of fins adapted to increase the surface area of the base to improve heat dissipation.

3. The apparatus of claim 2, wherein the base is constructed from forged aluminum alloy anodized for emissivity conduction.

4. The apparatus of claim 1, wherein the base comprises a mounting shelf coated with a thermally conductive material and where said mounting shelf is configured to connect the base to a circuit board.

5. The apparatus of claim 4, wherein the thermally conductive material comprises zinc oxide.

6. The apparatus of claim 4, wherein the thermally conductive material comprises copper.

7. The apparatus of claim 1, wherein the circuit board comprises a first circuit board wire conduit configured to accept a power supply wire.

8. The apparatus of claim 7, wherein the circuit board comprises a second circuit board wire conduit configured to accept a power supply wire.

9. The apparatus of claim 8, wherein the first circuit board wire conduit and the second circuit board wire conduit are co-located proximate to each other within the center region of the circuit board.

10. The apparatus of claim 9, wherein the first and second power supply wires are connected to the circuit board by mechanical crimping.

11. The apparatus of claim 1, wherein the power supply comprises a first insulated wire and a second insulated wire, said first and second insulated wire connected to the circuit board by mechanical crimping.

12. The apparatus of claim 1, wherein the power supply comprises a first insulated wire and a second insulated wire.

13. The apparatus of claim 12, where the first insulated wire and second insulated wire contain a hardened copper core.

14. The apparatus of claim 1, wherein the base further comprises a base plug constructed of thermally conductive and electrically insulative material.

15. The apparatus of claim 1, wherein the thermally conductive and electrically insulative material is a thermally conductive thermoplastic elastomer.

16. A base of uni-body design configured to act as a heat sync, the base constructed from forged metallic material and comprising a plurality of heat dissipating fins.

17. The base of claim 16, wherein the base is constructed from forged aluminum alloy.

18. The base of claim 16, wherein the base comprises a mounting shelf coated with a thermally conductive material and said mounting shelf is configured to connect the base to a circuit board.

19. The base of claim 16, wherein the thermally conductive material comprises zinc oxide and copper.

20. The base of claim 16, wherein the circuit board comprises a first circuit board wire conduit configured to accept a socket connector wire and said socket connector wire is mechanically crimped to the circuit board.
